(19) United States
(12) Patent Application Publication
(10) Pub. No.: US 2022/0140544 A1
(43) Pub. Date: May 5, 2022

(54) SHIELD CONNECTOR

(71) Applicant: Yazaki Corporation, Tokyo (JP)

(72) Inventor: Takakazu Takahashi, Shizuoka (JP)

(73) Assignee: Yazaki Corporation, Tokyo (JP)

(21) Appl. No.: 17/513,182

(22) Filed: Oct. 28, 2021

(30) Foreign Application Priority Data
Oct. 30, 2020 (JP) 2020-182159

(51) Int. Cl. H01R 13/6592; H01R 9/05

(52) U.S. Cl. CPC H01R 13/6592; H01R 9/0518

(57) ABSTRACT

A shield connector includes a shield wire that has a shield member that covers the outer periphery of a plurality of inner wires, an outer terminal that is electrically connected to the shield member of the shield wire, and an annularly formed sleeve that is disposed at an outer peripheral side of the plurality of inner wires and has the shield member that is disposed at the outer periphery, in which the outer terminal includes a crimping pieces that crimps the outer peripheral side of the sleeve and is electrically connected to the shield member, and the sleeve is formed in an elastically deformable manner and imparts a pressing force toward an inner surface side of the crimping pieces in a state where the crimping pieces is crimped.

### CROSS-REFERENCE TO RELATED APPLICATIONS

The present application is based on, and claims priority from Japanese Patent Application No. 2020-182159, filed on Oct. 30, 2020, the entire contents of which are incorporated herein by reference.

### TECHNICAL FIELD

The disclosure relates to a shield connector.

### BACKGROUND

JP 2012-48818 A discloses a shield connector that includes a shield wire that has a braid as a shield member that covers the outer periphery of a plurality of inner wires, and an outer terminal that is electrically connected to the braid of the shield wire. The shield connector includes an annularly formed sleeve that is disposed at an outer peripheral side of the plurality of inner wires, and has the braid that is disposed at the outer periphery of the sleeve.

### SUMMARY

In this shield connector, the outer terminal has a pair of barrels. The pair of barrels serves as the crimping pieces that crimp the outer peripheral side of the sleeve and are electrically connected to the braid. In this shield connector, the braid and the outer terminal are electrically connected by crimping the pair of barrels, and accordingly a shield circuit is formed.

However, in the shield connector, if a crimping piece of the outer terminal is crimped, the sleeve is plastically deformed so as to be reduced in diameter, and the shield wire is compressed radially inward. If this kind of compression of the shield wire occurs, the interval between each of the plurality of inner wires in the shield wire is shortened.

If the interval between each of the inner wires is shortened, the impedance may be partially disturbed at a portion of the shield wire, which portion is crimped by the crimping piece. If the impedance is disturbed, the transmission performance is deteriorated.

An object of the disclosure is to provide a shield connector capable of suppressing the deterioration in the transmission performance caused by the crimping performed by a crimping piece.

A shield connector according to the present embodiment includes a shield wire that includes a shield member that covers an outer periphery of a plurality of inner wires, an outer terminal that is electrically connected to the shield member of the shield wire, and an annularly formed sleeve that is disposed at an outer peripheral side of the plurality of inner wires, and includes the shield member that is disposed at the outer periphery of the sleeve, in which the outer terminal includes a crimping piece that crimps the outer peripheral side of the sleeve and is electrically connected to the shield member, and the sleeve is formed in an elastically deformable manner, and imparts a pressing force toward an inner surface side of the crimping piece in a state where the crimping piece is crimped.

The sleeve may include a separating portion at one position in a circumferential direction of the sleeve, and may be formed in an elastically deformable manner, the separating portion separating both end edges that face each other in the circumferential direction.

The sleeve may be disposed at the outer peripheral side of the plurality of inner wires, and may be crimped in an elastically deformable manner.

According to the disclosure, it is possible to provide a shield connector capable of suppressing the deterioration in the transmission performance caused by a crimping piece crimping an object.

### BRIEF DESCRIPTION OF THE DRAWINGS

FIG. 1 is an exploded perspective view of a shield connector according to the present embodiment:

FIG. 2 is a cross-sectional view of a shield connector according to the present embodiment:

FIG. 3 is a cross-sectional view of a portion where a crimping piece of a shield connector according to the present embodiment is positioned;

FIG. 4 is a perspective view of a sleeve before being assembled to a shield wire of a shield connector according to the present embodiment;

FIG. 5 is a side view when a sheath of a shield wire of a shield connector according to the present embodiment is peeled off:

FIG. 6 is a side view when a sleeve is assembled to the shield wire shown in FIG. 5;

FIG. 7 is a side view when a shield member of the shield wire shown in FIG. 6 is folded;

FIG. 8 is a side view when metal foil of the shield wire shown in FIG. 7 is peeled off; and

FIG. 9 is a side view when an inner terminal is assembled to an inner wire of the shield wire shown in FIG. 8.

### DETAILED DESCRIPTION

A shield connector according to the present embodiment will be described in detail below with reference to the drawings. The dimension ratio of each drawings is exaggerated for convenience of explanation, and may differ from the actual ratio.

A shield connector 1 according to the present embodiment includes a shield wire 7 and an outer terminal 9. The shield wire 7 has a shield member 5 that covers the outer periphery of a plurality of inner wires 3. The outer terminal 9 is electrically connected to the shield member 5 of the shield wire 7. Further, the shield connector 1 includes an annularly formed sleeve 11 that is disposed at the outer peripheral side of the plurality of inner wires 3. The shield member 5 is disposed at the outer periphery of the sleeve 11.

The outer terminal 9 is provided with a crimping pieces 13 that crimp the outer peripheral side of the sleeve 11 and are electrically connected to the shield member 5.

The sleeve 11 is formed in an elastically deformable manner, and imparts a pressing force toward an inner surface side of the crimping pieces 13 in a state in which the crimping pieces 13 are crimped.

The sleeve 11 has a separating portion 17 at one position in the circumferential direction of the sleeve and is formed in an elastically deformable manner. The separating portion 17 separates both end edges 15, 15 that face each other in the circumferential direction.

The sleeve 11 is disposed at the outer peripheral side of the plurality of inner wires 3, and is crimped in an elastically deformable manner.

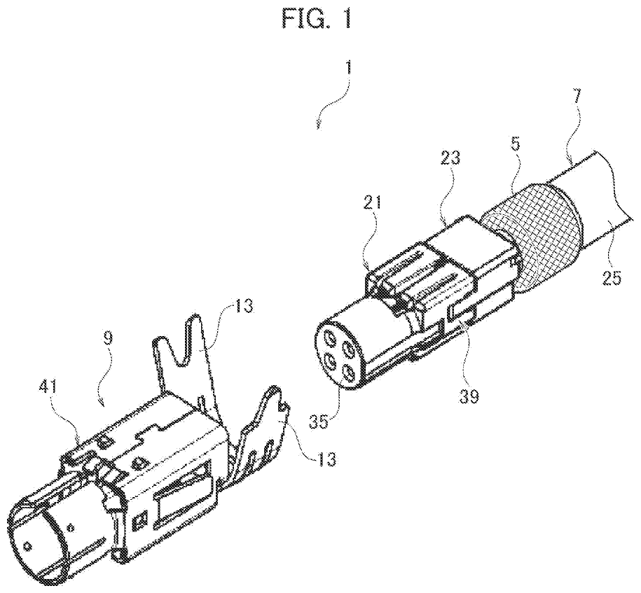

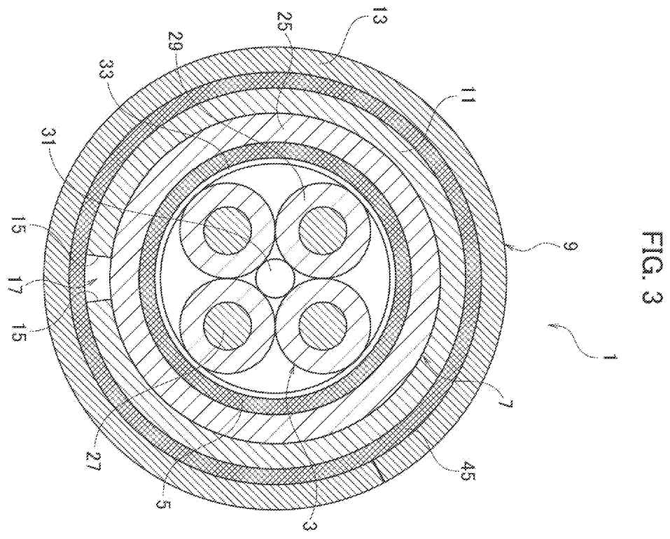

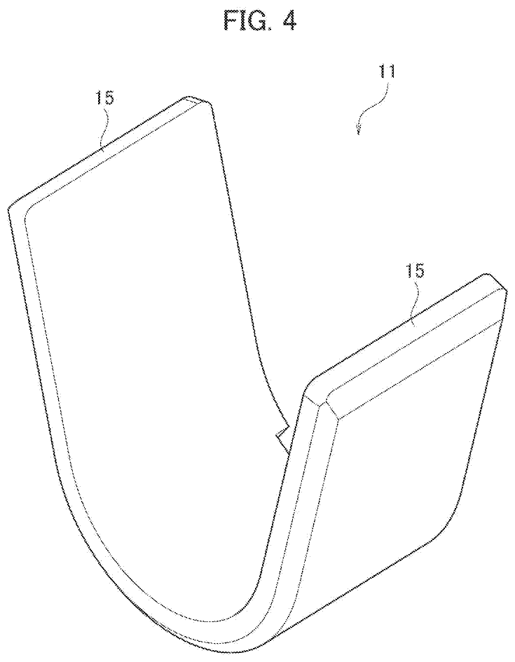

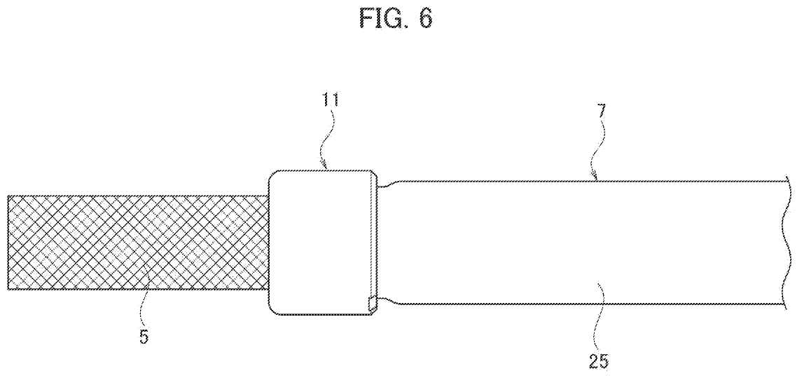

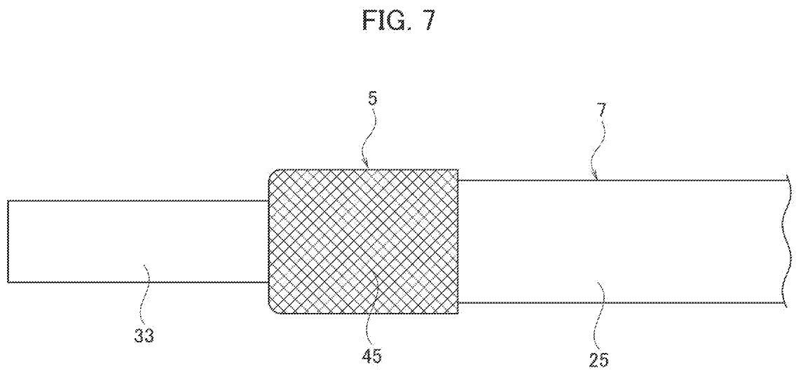

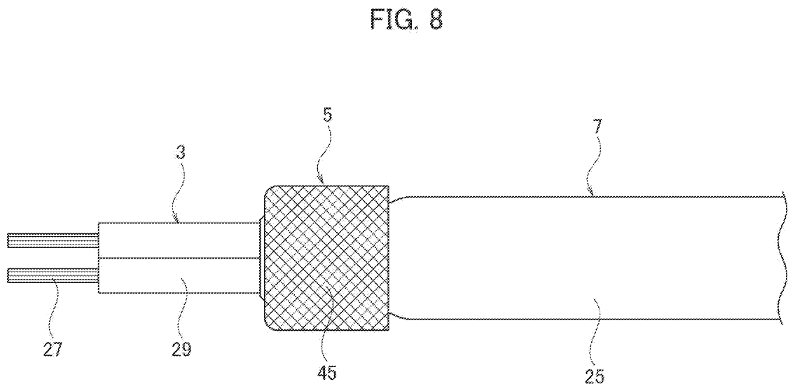

As shown in FIGS. 1 to 9, the shield connector 1 includes the shield wire 7, inner terminals 19, an inner housing 21, an insertion member 23, the outer terminal 9, and the sleeve 11.

As shown in FIGS. 1 to 3 and 5 to 9, the shield wire 7 includes the inner wire 3, the shield member 5, metal foil 33, and a sheath 25.

The inner wire 3 includes a core wire 27 made of a conductive material and an insulating coating 29 that is made of an insulating material and covers the outer periphery of the core wire 27. The core wire 27 may be a twisted wire in which a plurality of element wires are twisted. The inner wires 3 are in a state where the plurality of (in this diagram, four) inner wires 3 are twisted and bundled around a center material 31 disposed at the center of the shield wire 7. In this state, the outer periphery of the bundled inner wires 3 is covered with the shield member 5.

The shield member 5 is formed of braid which is obtained by braiding a plurality of element wires made of a conductive material. The shield member 5 is disposed so as to cover the outer periphery of the plurality of inner wires 3. In a space between the inner periphery of the shield member 5 and the outer periphery of the plurality of inner wires 3, metal foil 33 is disposed, which covers the outer periphery of the plurality of inner wires 3. The shield member 5 is not limited to being made of the braid, but may be made of metal foil or the like.

The sheath 25 is made of an insulating material, and is disposed so as to cover the outer periphery of the shield member 5. Nothing is formed between the inner periphery of the metal foil 33, and the outer periphery of the plurality of inner wires 3, and a vacant space is formed therebetween. The inner terminals 19 are electrically connected to the plurality of inner wires 3 of the shield wire 7 respectively.

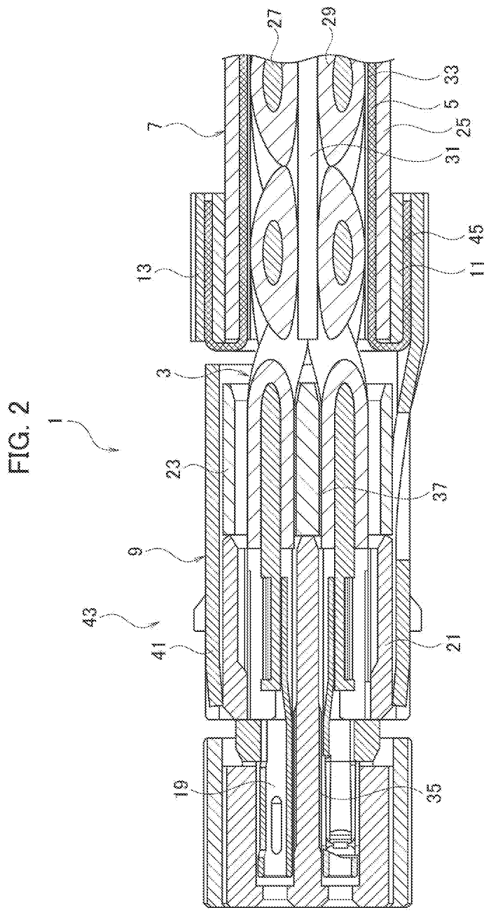

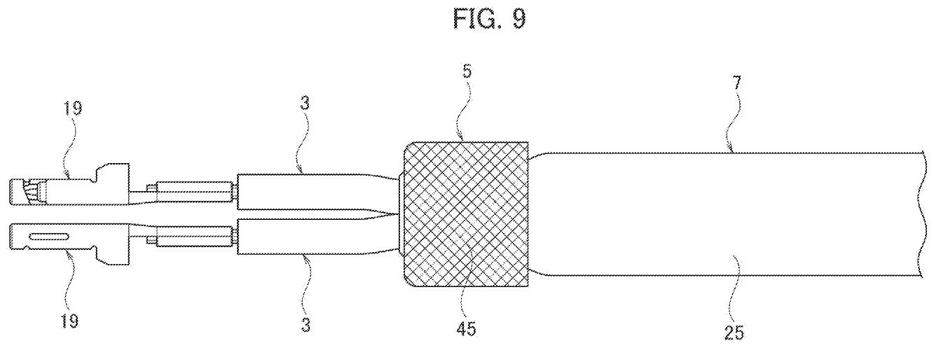

As shown in FIGS. 2 and 9, the inner terminals 19 are made of a conductive material, and are formed of a female terminal having a box-shaped connection portion. The inner terminals 19 are disposed respectively on the plurality of (in this case, four) inner wires 3 exposed from the sheath 25, the shield member 5, and the metal foil 33, at a terminal portion of the shield wire 7. The inner terminals 19 are electrically connected to the inner wires 3 respectively by pressure joining a crimping portion formed of the crimping pieces to the core wires 27 exposed from the insulating coating 29 of the inner wires 3. The inner terminals 19 electrically connected to the inner wires 3 of the shield wire 7 respectively are housed in the inner housing 21.

As shown in FIGS. 1 and 2, the inner housing 21 is made of an insulating material such as synthetic resin. The inner housing 21 is formed in a cylindrical shape so as to have a plurality (in this case, four) of terminal housing chambers 35 capable of housing the inner terminals 19. This inner housing 21 is housed in the outer terminal 9 in a state where the insertion member 23 is assembled to the inner housing 21, and maintains the insulation between the inner terminal 19 and the outer terminal 9.

As shown in FIGS. 1 and 2, the insertion member 23 is made of a conductive material, and is formed in a cylindrical shape. The insertion member 23 is provided with a plurality of (in this case, four) insertion holes 37. The plurality (in this case, four) of untwisted inner wires 3 exposed from the sheath 25, the shield member 5, and the metal foil 33 of the shield wire 7 are respectively inserted through the insertion holes 37. This insertion member 23 is assembled to the inner housing 21 through an engaging portion 39, and the insertion holes 37 communicate with the terminal housing chamber 35 of the inner housing 21.

The plurality of inner wires 3 of the shield wire 7 drawn out from the inner housing 21 are inserted through this insertion member 23, and the untwisted state of the plurality of inner wires 3 is maintained. The insertion member 23 also functions as an adjustment member for adjusting the impedance of the shield connector 1. The impedance can be matched by providing an adjustment portion or adjusting the thickness or a material.

As shown in FIGS. 1 to 3, the outer terminal 9 is made of a conductive material. The outer terminal 9 has a housing portion 41 and the crimping pieces 13 formed of a member that is continuous to the housing portion 41.

The housing portion 41 is formed in a cylindrical shape so as to house the inner housing 21 and the insertion member 23. The housing portion 41 houses the inner housing 21 and is disposed at the outer periphery of the inner terminals 19 via the inner housing 21 disposed between the housing portion 41 and the inner terminals 19 in the radial direction.

The crimping pieces 13 are formed of a member that is continuous to the housing portion 41, and are provided in a pair so as to be able to crimp the outer periphery of the shield wire 7. The pair of crimping pieces 13, 13 is crimped to the outer periphery of the shield member 5 of the shield wire 7. Accordingly, the shield member 5 and the outer terminal 9 are electrically connected each other.

This outer terminal 9 constitutes an inner module 43 together with the inner housing 21 and the insertion member 23. The inner housing 21 houses the inner terminal 19 at a terminal portion of the shield wire 7. The insertion member 23 is fixed integrally with the inner housing 21. The inner module 43 is housed in an outer housing (not shown) which can be fitted to a mating connector (not shown).

Fitting the outer housing to the mating connector electrically connects the inner terminals 19 to a mating terminal (not shown) housed in the mating connector. At this time, the outer terminal 9 is electrically connected to a conductive member (not shown) housed in the mating connector and grounded to form a shield circuit. In this way, by the outer terminal 9 forming the shield circuit, it is possible to prevent the leakage of noise from the core wire 27 of the inner wire 3, and the intrusion of noise to the core wire 27 of the inner wire 3.

In this shield connector 1, the sleeve 11 is disposed at a terminal portion of the shield wire 7 at which the crimping pieces 13 of the outer terminal 9 are crimped. The sleeve 11 is for maintaining the electrical connection between the shield member 5 and the outer terminal 9.

As shown in FIGS. 2 to 4 and 6, the sleeve 11 is made of a metal material, and is formed in a U-shape before being disposed at the shield wire 7. The sheath 25 is peeled off by a predetermined length at the terminal portion of the shield wire 7, and the shield member 5 is exposed. In the above state, the sleeve 11 is formed in an annular shape by being crimped such that both end edges 15, 15 are close to the outer periphery of the sheath 25. In a state where the sleeve 11 is crimped, both end edges 15, 15 are disposed to face each other while being separated in the circumferential direction via a separating portion 17 at one position in the circumferential direction of the sleeve 11. In this arrangement state, the sleeve 11 is elastically deformable such that both end edges 15, 15 move in the direction of approaching each other and separating from each other in the circumferential direction.

A shield folding portion 45 is disposed at the outer periphery of the sleeve 11 which is disposed in an elastically deformable manner. The shield folding portion 45 is obtained by folding the shield member 5 exposed from the sheath 25 toward the sheath 25 side. By crimping the crimping pieces 13 of the outer terminal 9 to the shield folding portion 45, the shield member 5 is held between the sleeve 11 and the crimping pieces 13 to maintain the electrical connection between the shield member 5 and the outer terminal 9.

If the sleeve 11 is plastically deformed to be reduced in diameter by crimping of the crimping pieces 13, a state is held in which the shield wire 7 is strongly compressed radially inward. If the strong compression of the shield wire 7 is held, a state is held in which the interval between each of the plurality of inner wires 3 is shortened in the shield wire 7. If the interval between each of the inner wires 3 is shortened, the impedance may be partially disturbed in the portion of the shield wire 7 which is crimped by the crimping pieces 13, and the transmission performance may be deteriorated.

Therefore, the sleeve 11 is formed in an elastically deformable manner. In this way, by forming the sleeve 11 in an elastically deformable manner, when the crimping pieces 13 are crimped, the sleeve 11 elastically deforms such that both end edges 15, 15 are close to each other. In a state where the crimping pieces 13 are crimped, a restoring force for separating both end edges 15, 15 acts on the elastically deformed sleeve 11. The restoring force of the sleeve 11 acts in a direction for enlarging the diameter of the sleeve 11, and the sleeve 11 imparts the pressing force on the inner surface side of the crimping pieces 13 through the shield folding portion 45.

In a state where the crimping pieces 13 are crimped, due to the restoring force of the sleeve 11, the sleeve 11 does not strongly compress the shield wire 7 radially inward. Therefore, the interval between each of the plurality of inner wires 3 in the shield wire 7 can be held close to the initial interval. Therefore, it is possible to suppress the partial disturbance of the impedance at the portion of the shield wire 7 which is crimped by the crimping pieces 13, and to suppress the deterioration in the transmission performance. In addition, by the sleeve 11 imparting the pressing force on the inner surface side of the crimping pieces 13, the shield member 5 and the crimping pieces 13 are stably bought into contact with each other, and the reliability of the electrical connection between the shield member 5 and the outer terminal 9 can be stabilized.

The crimping pieces 13 of the outer terminal 9 are crimped to the shield wire 7, and then expand in diameter due to spring-back. The sleeve 11 is formed in an elastically deformable manner, and thus the diameter of the sleeve 11 expands following the spring-back of the crimping pieces 13. Therefore, the compression force is eliminated by which the sleeve 11 compresses the shield wire 7 radially inward, and the interval between each of the plurality of inner wires 3 can be returned to the initial interval. If the spring-back of the crimping pieces 13 is taken into consideration, the interval between each of the plurality of inner wires 3 can be returned to the initial interval by forming the sleeve 11 in an elastically deformable manner, and the disturbance of the impedance caused by crimping of the crimping pieces 13 can be significantly suppressed.

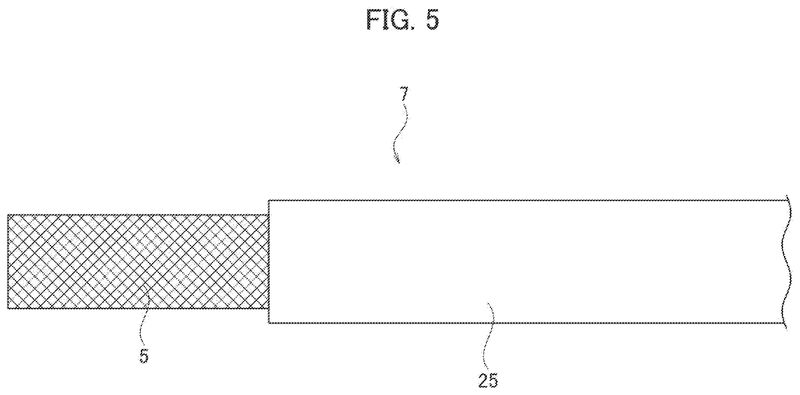

As shown in FIGS. 5 to 9, in the assembling of the shield connector 1 configured as described above, first the sheath 25 is peeled off by a predetermined length at the terminal portion of the shield wire 7. Next, the sleeve 11 is crimped and disposed at the outer periphery of the exposed sheath 25. Next, the shield folding portion 45 is formed by folding the shield member 5 exposed from the sleeve 11 toward the sheath 25 side so as to cover the sleeve 11. At this time, the excess length of the folded shield folding portion 45 is trimmed.

Next, the metal foil 33 is peeled off by a predetermined length, and the plurality of exposed inner wires 3 are untwisted. Next, each insulating coating 29 of each of the plurality of inner wires 3 is peeled off by a predetermined length, and each core wire 27 of each of the plurality of inner wires 3 is exposed. Next, the inner terminals 19 are assembled to the core wires 27 of the plurality of inner wires 3 respectively to electrically connect the inner terminals 19 and the core wires 27. Next, although not shown in the drawings, the inner terminals 19 are inserted through the insertion member 23, and housed in the inner housing 21 to assemble the insertion member 23 and the inner housing 21.

Although not shown in the drawings, the inner module 43 is assembled by housing the inner housing 21 and the insertion member 23 in the housing portion 41 of the outer terminal 9, and crimping the crimping pieces 13 to the shield folding portion 45 of the shield member 5 of the shield wire 7. The inner module 43 is housed in an outer housing (not shown) to complete the assembly of the shield connector 1.

In the shield connector 1, the sleeve 11 is formed in an elastically deformable manner, and the pressing force is imparted toward the inner surface side of the crimping pieces 13 in a state in which the crimping pieces 13 are crimped. Therefore, when the crimping pieces 13 are crimped, the sleeve 11 does not strongly compress the shield wire 7 radially inward. This allows the interval between each of the plurality of inner wires 3 in the shield wire 7 to be kept close to the initial interval.

Accordingly, in this shield connector 1, it is possible to suppress the partial disturbance of the impedance at the portion of the shield wire 7 which is crimped by the crimping pieces 13, and to suppress the deterioration in the transmission performance caused by crimping of the crimping pieces 13.

Further, the sleeve 11 has the separating portion 17 at one position in the circumferential direction of the sleeve 11, and is formed in an elastically deformable manner. The separating portion 17 separates both end edges 15, 15 facing each other in the circumferential direction. Therefore, the sleeve 11 can be formed in an elastically deformable manner with a simple structure without requiring a complicated structure.

Further, the sleeve 11 is crimped on the outer peripheral side of the plurality of inner wires 3 in an elastically deformable manner. Accordingly, the sleeve 11 can be easily assembled at any position of the shield wire 7, and the assembling performance of the sleeve 11 can be improved.

Although the present embodiment has been described above, the present embodiment is not limited thereto, and various modifications can be made within the scope of the gist of the present embodiment.

For example, the sleeve is formed in an elastically deformable manner by providing the separating portion at one position in the circumferential direction of the sleeve, but the disclosure is not limited thereto. For example, the sleeve can take any form, such as forming the sleeve itself from an elastic material that is elastically deformable in the radial direction, as long as the sleeve is elastically deformable.

Further, although the number of inner wires of the shield wire is four in the embodiment, the number is not limited thereto, and the number of inner wires may be three or less, or five or more.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A shield connector comprising:
a shield wire that includes a shield member that covers an outer periphery of a plurality of inner wires;
an outer terminal that is electrically connected to the shield member of the shield wire; and
an annularly formed sleeve that is disposed at an outer peripheral side of the plurality of inner wires, and includes the shield member disposed at the outer periphery of the sleeve, wherein
the outer terminal includes a crimping piece that crimps the outer peripheral side of the sleeve and is electrically connected to the shield member; and
the sleeve is formed in an elastically deformable manner, and imparts a pressing force toward an inner surface side of the crimping piece in a state where the crimping piece is crimped.

2. The shield connector according to claim 1, wherein
the sleeve includes a separating portion at one position in a circumferential direction of the sleeve, and is formed in an elastically deformable manner, the separating portion separating both end edges that face each other in the circumferential direction.

3. The shield connector according to claim 1, wherein
the sleeve is disposed at the outer peripheral side of the plurality of inner wires, and is crimped in an elastically deformable manner.
